(19) United States
(12) Patent Application Publication
(10) Pub. No.: US 2017/0134811 A1
(43) Pub. Date: May 11, 2017

(54) MOBILE HIGH-DEFINITION STUDIO

(71) Applicant: Big Ten Network, LLC, Chicago, IL (US)

(72) Inventors: Michael J. Calderon, Wheeling, IL (US); Michael G. Wilken, Naperville, IL (US); Jason A. Bryant, Chicago, IL (US); Scott C. Adametz, Chicago, IL (US); Jeffrey J. Backerman, Chicago, IL (US)

(21) Appl. No.: 15/233,224

(22) Filed: Aug. 10, 2016

Related U.S. Application Data
(63) Continuation of application No. 13/099,350, filed on May 2, 2011, now abandoned.
(60) Provisional application No. 61/330,280, filed on Apr. 30, 2010.

(51) Int. Cl. H04N 21/472; H04N 5/91; H04N 21/234; H04N 5/77; H04N 21/2187; H04N 21/61

(52) U.S. Cl. CPC H04N 21/47202; H04N 21/2187; H04N 21/6125; H04N 21/23424; H04N 5/772; H04N 5/91; H04M 7/006

(57) ABSTRACT

An HD content acquisition and distribution system includes a central distributor disposed to encode and serve HD content and a plurality of modular packaged content acquisition equipment disposed to be deployed at a live event and in at least partial communication with the central distributor. The content acquisition equipment includes recording equipment, processing equipment, transmission equipment, and communications equipment. The recording equipment includes at least one camera, digital recording device, and digital production device. The processing equipment includes audio/video processing equipment. The transmission equipment includes equipment configured to be interfaced with an existing network for content transmission to the central distributor, and a backup transmission path. The communications equipment includes VOIP equipment configured to allow communication between personnel operating the content acquisition equipment and the central distributor.

### CROSS REFERENCE TO RELATED APPLICATIONS

This patent application claims priority to U.S. Provisional Application No. 61/330,280 filed Apr. 30, 2010, and to U.S. patent application Ser. No. 13/099,350 filed May 2, 2011, and is a Continuation of U.S. patent application Ser. No. 13/099,350 filed May 2, 2011, which applications are incorporated herein by reference in their entirety.

### TECHNICAL FIELD

The present invention is generally related to video acquisition and transmission, and more particularly, example embodiments of the present invention are direct to highly portable, modular, and mobile high-definition studios and systems for distribution of high-definition content acquired through such studios.

### BACKGROUND OF THE INVENTION

Conventionally, acquisition and distribution of high-definition (HD) content of live events (e.g., concerts, sporting events, etc.) requires a dedicated HD camera system including a plurality of cameras, a dedicated transmission point for transmitting HD content of the live events to a content broadcaster, and the content broadcaster itself, which is typically a cable or television network.

It follows that drawbacks to these conventional means include the inability to effectively offer HD coverage of small, lesser known venues due to the high-cost involved in preparation and distribution (content recording, transmission, and broadcasting time) of the HD content.

Therefore, it is apparent that a need exists for means for content acquisition and distribution that overcome these drawbacks.

### SUMMARY

According to one embodiment of the present invention, an HD content acquisition and distribution system includes a central distributor disposed to encode and serve HD content and a plurality of modular packaged content acquisition equipment disposed to be deployed at a live event and in at least partial communication with the central distributor. The content acquisition equipment includes recording equipment, processing equipment, transmission equipment, and communications equipment. The recording equipment includes at least one camera, digital recording device, and digital production device. The processing equipment includes audio/video processing equipment. The transmission equipment includes equipment configured to be interfaced with an existing network for content transmission to the central distributor, and a backup transmission path. The communications equipment includes VOIP equipment configured to allow communication between personnel operating the content acquisition equipment and the central distributor.

According to an additional embodiment of the present invention, a high-definition (HD) content acquisition method includes retrieving a plurality of modular packaged content acquisition equipment transported to a live event, the content acquisition equipment including recording equipment, processing equipment, transmission equipment, and communications equipment, wherein the recording equipment includes at least one camera, digital recording device, and digital production device, wherein the processing equipment includes audio/video (AV) processing equipment, wherein the transmission equipment includes equipment configured to be interfaced with an existing network for content transmission to a central distributor and a backup transmission path, and wherein the communications equipment includes voice-over-Internet-protocol (VOIP) equipment configured to allow communication between personnel operating the content acquisition equipment and the central distributor. The method further includes deploying the retrieved content acquisition equipment at the live event, acquiring HD content of the live event using the deployed equipment, and transmitting the acquired HD content to the central distributor.

According to yet another additional embodiment of the present invention, a high-definition (HD) content distribution method includes receiving HD content acquired from a plurality of modular packaged content acquisition equipment transported to a live event, the content acquisition equipment including recording equipment, processing equipment, transmission equipment, and communications equipment, wherein the recording equipment includes at least one camera, digital recording device, and digital production device, wherein the processing equipment includes audio/video (AV) processing equipment, wherein the transmission equipment includes equipment configured to be interfaced with an existing network for content transmission to a central distributor and a backup transmission path, and wherein the communications equipment includes voice-over-Internet-protocol (VOIP) equipment configured to allow communication between personnel operating the content acquisition equipment and the central distributor. The method further includes ingesting video and audio of the received HD content at an audio/video (AV) ingest portion of the central distributor, exporting the ingested HD content at an AV export portion of the central distributor, encoding the exported HD content into a video-on-demand (VOD) appropriate format, and serving the encoded HD content to a plurality of end users on demand.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views. Furthermore, each drawing contained in this provisional application includes at least a brief description thereon and associated text labels further describing associated details. The Figures:

FIG. 1 illustrates a High-Definition content acquisition system, according to an example embodiment of the present invention;

FIG. 2 illustrates a High-Definition content distribution system, according to an example embodiment of the present invention;

FIG. 3 illustrates a method of acquiring High-Definition content, according to an example embodiment of the present invention; and

FIG. 4 illustrates a method of distributing High-Definition content, according to an example embodiment of the present invention.

### DETAILED DESCRIPTION

Further to the brief description provided above and associated detail of each of the figures, the following description provides additional details of example embodiments of the present invention.

Example embodiments are directed to HD content acquisition and distribution systems and methods which enable low-cost provision of HD content to users wishing to view live events that may not be available over cable or television networks. According to example embodiments, HD content of a live event is acquired and encapsulated through deployed production and recording equipment including the illustrated equipment. The encapsulated content, or alternatively raw content, is transmitted to a central distributor through an existing network such as a wide area network, LAN, or the Internet through connections near or on the live event site. There may also be a backup transmission path for reliability. The HD content is received at the central distributor and ingested. For example AVID® ingestion for digital media may be utilized. The ingested content is exported and encoded into a standard format, for example audio-video interleave file format, QUICKTIME® format, or any other suitable format. The encoded content may then be stored for Video-on-demand distribution at the central distributor or at a separate Video-on-demand distributor.

Additionally, the received content may be immediately encoded without ingestion, for example, at an encoding server. The encoded content may be served as Video-on-demand, through a live network, and/or through a website/web-distributor.

According to example embodiments, packed equipment may be retrieved and deployed for an event to be recorded. Audio-video equipment may be interconnected, and telecommunications equipment may be interconnected. The telecommunications equipment may allow communication to the central distributor for HD content transmission, communication with on-site personnel, and between on-site personnel. Using the deployed equipment, the HD content is acquired as video and audio information and recorded. The HD content may also be processed at a production station deployed on-site. There may be included announcements, advertising, commenting, and or any other available features for the event, including scores, scoring, graphics, etc. Upon acquisition/production, the HD content is transmitted to a central distributor for further processing as described herein.

According to example embodiments, telecommunications and transmission equipment packaged as illustrated may be deployed to be in communication with the central distributor through a private network, dedicated network, dedicated high-speed or broadband network, and/or any suitable communications medium. Control, administration, and monitoring of deployed equipment may be facilitated through the telecommunications and transmission equipment from the central distributor.

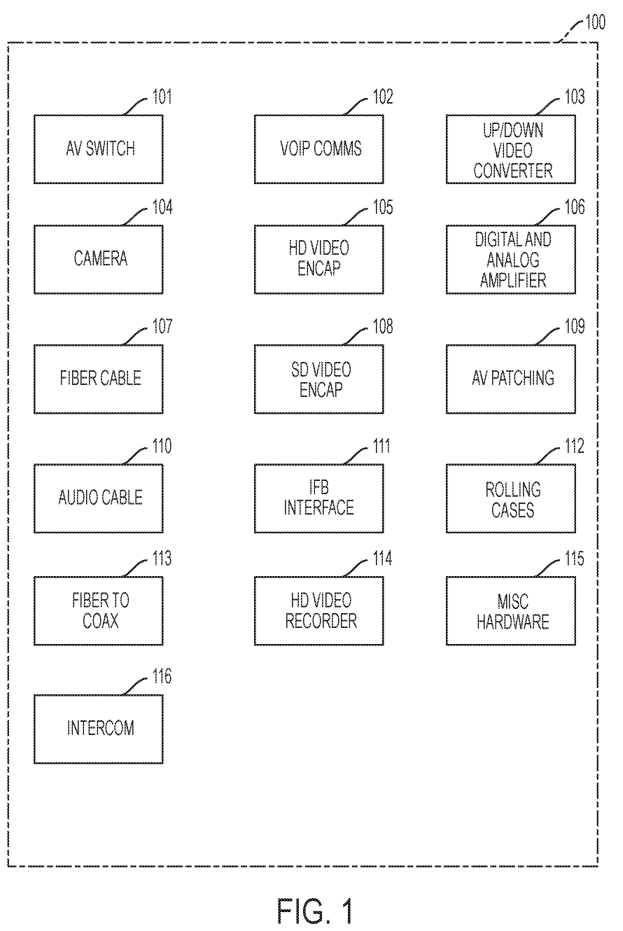

FIG. 1 illustrates a High-Definition content acquisition system including packed equipment, according to an example embodiment of the present invention. The equipment and/or components of the system 100 may be pack in rugged, modular containers (e.g., rolling cases 112) easily deployable at any desired live event (e.g., sporting event, concert, etc.). Therefore, the system 100 may include a plurality of the rugged, modular containers with each container being disposed to safely transport any particular portion or portions of the system 100 described below.

The system 100 includes audio/video (AV) switch(s) 101. The AV switch, or switches, may allow aggregation of HD content from a plurality of HD acquisition means (e.g., cameras, microphones, recorders etc.).

The system 100 further includes voice-over-Internet-protocol (VOIP) communication means 102. The VOIP means 102 may include any suitable VOIP equipment configured and disposed to enable VOIP communication through any available network. Such may include VOIP modems, routers, telephony devices, and/or any other suitable VOIP means.

The system 100 further includes up/down video converter(s) 103. The video converter 103, or converters, may include any format converter configured to process and convert audio/video acquired through any acquisition means described herein.

The system 100 further includes at least one HD camera 104 and HD video recorder 114. According to one example embodiment, three or more HD capable cameras and at least one HD recorder are included in the system 100. Each HD camera 104 may be a portable or reasonably portable HD capturing device capable of capturing at least video content. Each HD video recorder 114 may be a portable or reasonably portable HD video recording device capable or recording an applied HD signal, whether audio, video, or any combination thereof. According to other example embodiments, the HD cameras 104 may be capable of capturing both HD video and audio. According to other example embodiments, the HD cameras 104 may be capable of selectively recording audio from a plurality of separate sources, including remote or accessory microphones. The HD cameras 104 may be externally (e.g., mains) or internally (e.g., battery) powered devices.

The system 100 further includes HD video encapsulator 105 and standard definition (SD) video encapsulator 108. The encapsulator 105 may be any suitable processing device capable of containerizing HD content for transmission to a plurality of end-devices or a central distributor. The encapsulator 108 may be any suitable processing device capable of containerizing SD content for transmission to a plurality of end-devices or a central distributor.

The system 100 further includes digital and analog amplifier(s) 106. The amplifier 106, or amplifiers, may be any suitable amplifiers configured to process and condition digital and/or analog systems for use in the system 100.

The system 100 further includes communication cabling 107 and 110. The cabling 107 may be fiber optic cabling and the cabling 110 may be any cabling suitable for transmission of audio signals, for example, coaxial cabling. It follows that the system 100 may further include AV patching 109 and mating components 113. For example, mating components 113 may include fiber-to-coax mating components such that signals from optical fiber may be converted and coupled to coax for transmission and vice versa.

The system 100 further includes intercom system 116 and IFB interface 111 for on-site communication, for example, through interruptible feedback and intercom operations by users deploying and using the system 100 for acquisition of HD content.

Finally, the system 100 may also include any necessary or desired additional and/or miscellaneous equipment and hardware 115 to facilitate acquisition of HD content. For example, the additional equipment may include computing apparatuses, audio and video processing equipment, or any other suitable equipment.

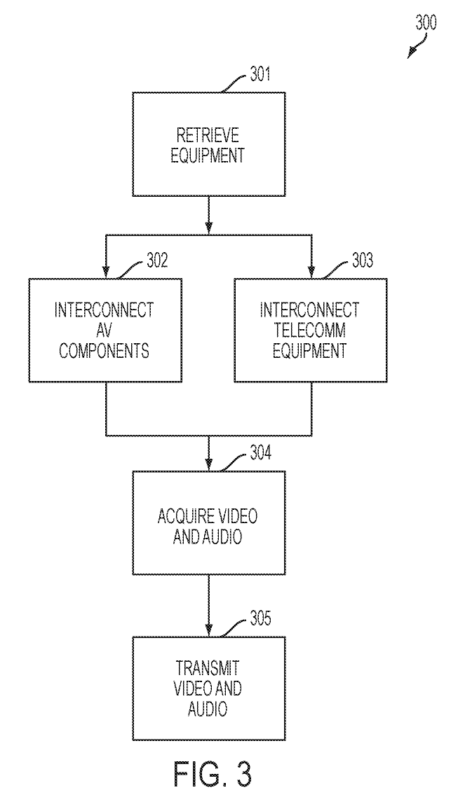

The components of system 100 may be transported or shipped to a location for acquisition of HD content of a live event in the rugged, modular containers described above. Upon arrival, the equipment may be unpackaged and set up in any desired manner such that HD content may be captured and recorded. On site communications through intercom and IFB equipment may allow ease of use and direction for the deploying users. Methods of deployment and HD content acquisition are described in detail with reference to FIG. 3.

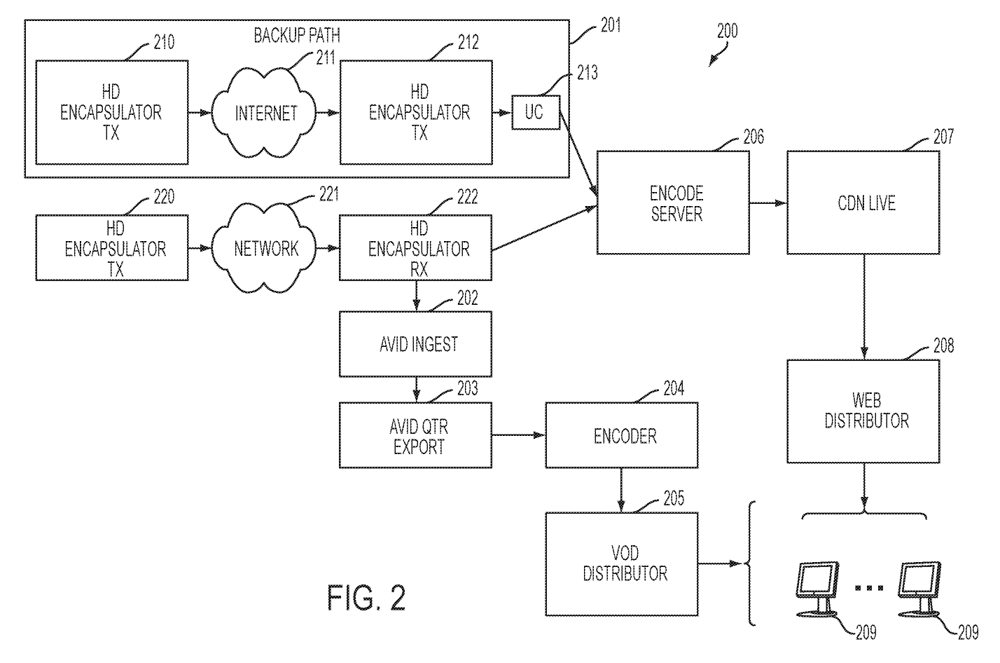

Upon acquisition, or at substantially the same time, the HD content may be encapsulated and transmitted to a central distributor or distribution system 200, as illustrated in FIG. 2.

The system 200 includes HD encapsulator transmission portion 220. The transmission portion 220 may be configured to transmit encapsulated and/or containerized HD content over network 221. The network 221 may be any available on-site network, for example, a back-end communications network, private network, dedicated network, dedicated high-speed or broadband network, and/or any suitable communications medium including the Internet. The system 200 further includes HD encapsulator receiving portion 222. The receiving portion 222 may be configured to receive HD content transmitted over network 221, and relay the content to encode server 206.

The system 200 may also include a backup transmission path 201 for receipt of HD content for relay to encode server 206. For example, the backup transmission path 201 may include dedicated or repurposed HD encapsulator transmission portions 210 and receiving portions 212 at least somewhat similar in operability to portions 220 and 222. The backup transmission path 201 may further include uplink communications portion 213 configured to transmit encapsulated HD content to the server 206. The backup transmission path 201 may be remote or separate from the system 200, for example off site of a central distributor.

The encode server 206 may be a processing/server device configured to encode encapsulated HD content for use in a HD delivery system. For example, the encode server 206 may be configured to process and encode encapsulated HD content into media easily digestible and distributed through a website. A plurality of suitable encoding options exist, thus, example embodiments are applicable to any desired encoding option.

The system 200 further includes centralized live web server 207. The centralized live web server 207 may be a web server configured to receive and store encoded content for distribution to a plurality of web distributors (e.g., 208). For example, centralized web server 207 may receive encoded HD content from encode server 206, and may organize, prioritize, and store the encoded content. Upon requests from content from web distributor 208, the centralized web server 207 may search and retrieve requested content, and provide the retrieved content to web distributor 208. According to some example embodiments, encryption and/or authorized access protocols may be employed between the centralized live server 207 and any web distributor to ensure authorized access to stored encoded content is facilitated. Upon receipt of requested content, the web distributor 208 may serve the requested content to end-users or subscribers 209.

Alternatively, or in combination, received HD content may be received and ingested at ingest portion 202. According to one example embodiment, ingest portion 202 may be a configurable AVID® ingestion portion. The ingested content is exported and encoded into a standard format at export portion 203 and encoder 204, for example, as audio-video interleave file format, QUICKTIME® format, or any other suitable format. The encoded content may then be stored for Video-on-demand (VOD) distribution at a central distributor embodying the system 200 or at a separate VOD distributor 205. Upon appropriate and/or authorized request from any user/subscriber 209, HD content may be provided by the system 200, for example, through the VOD distributor 205.

According to example embodiments, a centralized distributor may employ any or all of portions of the system 200, with any other suitable, necessary, or desired portions being provided through third parties or authorized distributors. Therefore, although illustrated as including both the web distributor 208 and VOD distributor 205, it should be appreciated that a centralized distributor may also provide encoded HD content to separate web distributors and/or VOD distributors without departing from the spirit and scope of example embodiments. For example, according to one example embodiment, a centralized distributor includes at least the encode server 206 and centralized live server 207 for distribution of content to web distributors. According to another example embodiment, a centralized distributor includes ingest portion 202, export portion 203, and encoder portion 204 for centralized distribution of HD content to a separate VOD distributor. According to yet another example embodiment, a centralized distributor includes any combination of the two alternatives provided above including centralized VOD distribution and web distribution.

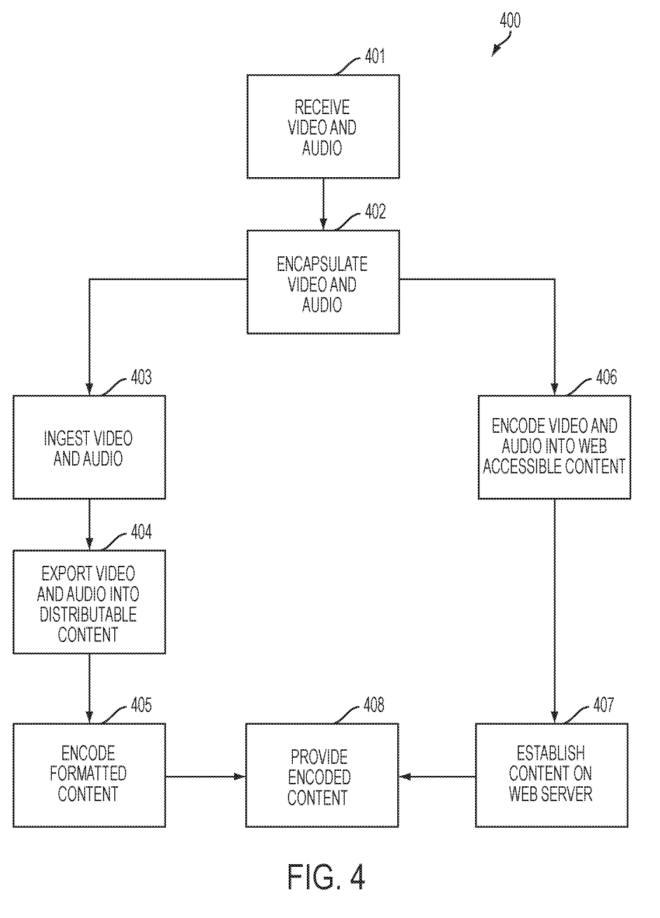

Hereinafter, methods of HD content acquisition and distribution are described in detail with reference to FIGS. 3-4.

FIG. 3 illustrates a method of acquiring High-Definition content, according to an example embodiment of the present invention. The method 300 includes retrieving HD acquisition equipment at block 301. For example suitable equipment may include any portion of the HD acquisition system 100. The equipment may be retrieved from the rugged, portable storage containers described above.

The method 300 further includes interconnecting audio and video components of the equipment at block 302. For example, interconnecting the AV components includes appropriately interconnecting HD video and audio capturing components and recording components, including microphones, cameras, and/or associated cabling such that captured HD content may be recorded and transmitted over a network appropriately.

The method 300 further includes interconnecting telecommunications equipment of the retrieved equipment at block 303. Interconnecting the telecommunications equipment may include interconnecting intercom and communications devices such that users of the interconnected AV components may be able to easily communicate between one another and to a centralized distributor over a network.

The method 300 further includes acquiring HD video and audio at block 304. For example, acquiring HD video and audio may include activating and running HD content acquisition devices such as cameras and microphones in any desired manner. The acquiring may also include enveloping associated score information, session information, advertising, or any other suitable content within the acquired HD content. For example, if deployed at a live sporting event, acquiring HD video and audio may include capturing video through one or more deployed cameras, capturing audio through one or more microphones, processing the captured audio and video to incorporate advertising and/or scoring information, and recording the same. The additional scoring, advertising, or other content may be incorporated through use of a computing device or otherwise capable HD recording device. For example, advertisements, banners, scoring headers/tickers, or any other suitable information may be overlayed/incorporated using a chroma key through an AV switcher or other device.

Upon acquiring and recording, the HD content is transmitted to a centralized distributor over a network at block 305.

Therefore, example embodiments of the present invention provide HD Video feeds, portability and ease of use, modular equipment for efficient changes/upgrades and for efficient transportation, easily deployable camera equipment for deployment at a variety of live events, reliability through equipment protection in modular cases, communication between production personnel and central content provider, and transmission of content to a central content provider.

FIG. 4 illustrates a method of distributing captured High-Definition content, according to an example embodiment of the present invention. The method 400 includes receiving recorded or live audio and video from a deployed system 100 at block 401. For example, a deployed system 100 may be any suitable acquisition system arranged to capture and transmit HD content according to FIGS. 1 and 3.

The method 300 further includes encapsulating video and audio at block 402. For example, encapsulating video and audio may include containerizing recorded HD video and audio for transmission to a centralized distributor. It should be noted that although illustrated as being accomplished at a central content provider, the same may be accomplished on site at a desired event. For example, as the system 100 may include encapsulation equipment, HD content may be encapsulated for transmission at the event before receipt at a central content provider.

The method 400 further includes ingesting video and audio at block 403. The method 400 further includes exporting ingested video and audio into distributable content at block 404. The method 400 further includes encoding the distributable content into formatted content at block 405. The formatted content may be formatted into any suitable format for distribution to a plurality of users/subscribers, for example, as described in detail with reference to FIG. 2, above.

The encoded content may subsequently be provided at block 408, for example, to any authorized requesting user/subscriber.

The method 400 may also include encoding encapsulated video and audio into web-accessible content at block 406, for example, as described in detail with reference to FIG. 2. The web-accessible content may be established or placed on a web server or web distributor at block 407.

The encoded web-accessible content may subsequently be provided at block 408, for example, to any authorized requesting user/subscriber.

Therefore, as described above, example embodiments of the present invention provide mobile high-definition studios/equipment which may be used in a system including a central distributor to efficiently acquire, transmit, and serve HD content for a variety of events. The modular equipment may be packed in rugged packaging such that it may be easily transported with less failure and increased reliability. The equipment may be monitored through the central distributor and may be used for on-site editing and production of feature-rich event content including announcer's comments, advertising, or any suitable features. The monitoring may be facilitated through communications equipment contained in the modular system. The monitoring may facilitate on-site communication between users of deployed content acquisition equipment and personnel of the central distributor. The modular, portable equipment may be easily deployable such that even small venues or lesser-known events may be provided through the central distributor.

The central distributor may provide the acquired content through a web-site, on-demand service, or other suitable means. The content may be encoded into any suitable format depending upon the desired form of distribution. For example, the content may be encoded as FLASH® or H.264 for distribution on a website or internet broadcasting. The content may be stored at a central database or a plurality of databases/servers for future distribution. Furthermore, content may be live-fed through a website or broadcast channel or substantially live-fed as it is transmitted from the deployed equipment to the central distributor.

The methodologies of content distribution, encoding, hosting, video-on-demand, and other processing of example embodiments of the present invention can be implemented in hardware, software, firmware, or a combination thereof. Embodiments may be implemented in software or firmware that is stored in a memory and that is executed by a suitable instruction execution system. These systems may include any or a combination of the following technologies, which are all well known in the art: discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of at least one example embodiment of the present invention in which functions may be executed out of order from that shown or discussed, including substantially concurrently or in reverse order, depending on the functionality involved, as would be understood by those reasonably skilled in the art of the present invention.

Any program which would implement functions or acts noted in the figures, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium, upon which the program is printed, as the program can be electronically captured, via for instance optical scanning of the paper or other medium, then compiled, interpreted or otherwise processed in a suitable manner if necessary, and then stored in a computer memory. In addition, the scope of the present invention includes embodying the functionality of the preferred embodiments of the present invention in logic embodied in hardware or software-configured mediums.

It should be emphasized that the above-described embodiments of the present invention, particularly, any detailed discussion of particular examples, are merely possible examples of implementations, and are set forth for a clear understanding of the principles of the invention. Many variations and modifications may be made to the above-described embodiments of the invention without departing substantially from the spirit, scope, and principles of the invention. All such modifications and variations are intended to be included herein within the scope of this disclosure and the present invention and protected by the following claims.

1. A high-definition (HD) content acquisition and distribution system, comprising:
a central distributor disposed to encode and serve HD content; and
a plurality of modular packaged content acquisition equipment disposed to be deployed at a live event and in at least partial communication with the central distributor, the content acquisition equipment including recording equipment, processing equipment, transmission equipment, and communications equipment; wherein,
the recording equipment includes at least one camera, digital recording device, and digital production device;
the processing equipment includes audio/video (AV) processing equipment;
the transmission equipment includes equipment configured to be interfaced with an existing network for content transmission to the central distributor, and a backup transmission path; and
the communications equipment includes voice-over-Internet-protocol (VOIP) equipment configured to allow communication between personnel operating the content acquisition equipment and the central distributor.

2. The system of claim 1, wherein the central distributor comprises:
an encode server in at least partial communication with the content acquisition equipment and disposed to encode HD content received from the content acquisition equipment into a web-distributable content format; and
a centralized live web server in communication with the encode server and disposed to serve the encoded HD content to a plurality of end users.

3. The system of claim 2, wherein the web-distributable format is a video media format for distribution to the plurality of end users over a webpage.

4. The system of claim 1, wherein the central distributor comprises:
an audio/video (AV) ingest portion in at least partial communication with the content acquisition equipment and disposed to ingest HD content received from the content acquisition equipment;
an AV export portion in communication with the AV ingest portion and disposed to export ingested HD content for encoding;
an encode server in communication with the AV export portion and disposed to encode exported HD content into a video-on-demand (VOD) appropriate format; and
a VOD distribution portion in communication with the encode server and disposed to serve the encoded HD content to a plurality of end users on demand.

5. The system of claim 4, wherein the VOD appropriate format is a video media format for distribution to the plurality of end users through a VOD system.

6. The system of claim 4, wherein the central distributor further comprises:
a second encode server in at least partial communication with the content acquisition equipment and disposed to encode HD content received from the content acquisition equipment into a web-distributable content format; and
a centralized live web server in communication with the encode server and disposed to serve the encoded HD content to the plurality of end users.

7. The system of claim 6, wherein the web-distributable format is a video media format for distribution to the plurality of end users over a webpage.

8. The system of claim 1, wherein:
the plurality of modular packaged content acquisition equipment is packaged in customized rugged containment vessels disposed to be transported to the live event and disposed to allow fast deployment of equipment packed therein.

9. The system of claim 1, wherein the recording equipment further comprises at least three HD cameras, at least one HD digital recording device, and at least one computer apparatus configured to process HD video captured at the at least three HD cameras and store the processed HD video at the at least one HD digital recording device.

10. The system of claim 9, wherein the at least one computer apparatus is further configured to incorporate event-specific information onto the captured HD video for storage on the at least one HD digital recording device.

11. The system of claim 10, wherein the event-specific information is at least one of advertising information and score information.

12. The system of claim 1, wherein the AV processing equipment includes at least one AV switch configured to interconnect the recording equipment and transmission equipment.

13. The system of claim 1, wherein the transmission equipment comprises an HD content encapsulator configured to containerize HD content captured at the live event for transmission to the central distributor.

14. A high-definition (HD) content acquisition method, comprising:
retrieving a plurality of modular packaged content acquisition equipment transported to a live event, the content acquisition equipment including recording equipment, processing equipment, transmission equipment, and communications equipment, wherein the recording equipment includes at least one camera, digital recording device, and digital production device, wherein the processing equipment includes audio/video (AV) processing equipment, wherein the transmission equipment includes equipment configured to be interfaced with an existing network for content transmission to a central distributor and a backup transmission path, and wherein the communications equipment includes voice-over-Internet-protocol (VOIP) equipment configured to allow communication between personnel operating the content acquisition equipment and the central distributor;
deploying the retrieved content acquisition equipment at the live event;
acquiring HD content of the live event using the deployed equipment; and
transmitting the acquired HD content to the central distributor.

15. The method of claim 14, further comprising encapsulating the acquired HD content for transmission with the transmission equipment.

16. The method of claim 14, further comprising:
receiving, at the central distributor, the transmitted HD content;
ingesting video and audio of the received HD content at an audio/video (AV) ingest portion of the central distributor;
exporting the ingested HD content at an AV export portion of the central distributor;
encoding the exported HD content into a video-on-demand (VOD) appropriate format; and
serving the encoded HD content to a plurality of end users on demand.

17. The method of claim 14, further comprising:
encoding the received HD content into a web-distributable content format; and
serving the encoded HD content to the plurality of end users over a web interface.

18. A high-definition (HD) content distribution method, comprising:
receiving HD content acquired from a plurality of modular packaged content acquisition equipment transported to a live event, the content acquisition equipment including recording equipment, processing equipment, transmission equipment, and communications equipment, wherein the recording equipment includes at least one camera, digital recording device, and digital production device, wherein the processing equipment includes audio/video (AV) processing equipment, wherein the transmission equipment includes equipment configured to be interfaced with an existing network for content transmission to a central distributor and a backup transmission path, and wherein the communications equipment includes voice-over-Internet-protocol (VOIP) equipment configured to allow communication between personnel operating the content acquisition equipment and the central distributor;
ingesting video and audio of the received HD content at an audio/video (AV) ingest portion of the central distributor;
exporting the ingested HD content at an AV export portion of the central distributor;
encoding the exported HD content into a video-on-demand (VOD) appropriate format; and
serving the encoded HD content to a plurality of end users on demand.

19. The method of claim 18, further comprising:
encoding the received HD content into a web-distributable content format; and
serving the encoded HD content to the plurality of end users over a web interface.
